(19) United States
(12) Patent Application Publication
(10) Pub. No.: US 2015/0212967 A1
(43) Pub. Date: Jul. 30, 2015

(54) Wireless Communication Adaptor And Receiver Device With Integrated Speakers

(71) Applicant: Eric Jermaine Griffin, Riverdale, MD (US)

(72) Inventor: Eric Jermaine Griffin, Riverdale, MD (US)

(21) Appl. No.: 14/609,410

(22) Filed: Jan. 29, 2015

Related U.S. Application Data
(60) Provisional application No. 61/933,827, filed on Jan. 30, 2014.

(51) Int. Cl. G06F 13/40; H04W 4/00

(52) U.S. Cl. CPC G06F 13/4081; H04W 4/008

(57) ABSTRACT

A wireless communication adaptor and receiver device (WCARD) including a communication unit, electrical connectors, an authentication module, an acoustic unit, a recording unit, and a power charging unit is provided. The communication unit wirelessly communicates with a portable electronic device (PED). The electrical connectors connect the WCARD to a docking station and/or the PED. The authentication module authenticates the PED. The acoustic unit plays media received wirelessly from the PED. The acoustic unit configured as a speaker and/or a microphone establishes a duplex communication. The recording unit, through a wired connection or a wireless connection, receives and records input data from the PED. A device management system provided on the PED remotely manages the WCARD by configuring the WCARD to connect to a wireless network, wirelessly transmitting an authentication code, media, and input data to the WCARD, and activating the power charging unit to transmit power to the PED.

### CROSS REFERENCE TO RELATED APPLICATIONS

This application claims priority to and the benefit of provisional patent application No. 61/933,827 titled “Wireless Communication Adaptor And Receiver Device With Integrated Speakers”, filed in the United States Patent and Trademark Office on Jan. 30, 2014. The specification of the above referenced patent application is incorporated herein by reference in its entirety.

### BACKGROUND

Conventionally, if a user wants to listen to media, for example, music stored on the user's portable electronic device, for example, a cell phone, a portable media player, etc., through a docking station, the user must connect the portable electronic device directly to the docking station, and therefore cannot carry the portable electronic device and move freely around a place while listening to the media. Although there are some wireless adaptor devices that establish a wireless communication between the portable electronic device and the docking station, and allow a user to play the media stored on the user's portable electronic device wirelessly through the docking station, when docked on the docking station, these wireless adaptor devices are not configured with integrated speakers and therefore fail to function as portable speakers that allow the user to listen to the media when the user is in transit or when the docking station is unavailable to the user.

Conventional portable speakers wirelessly play media stored on a portable electronic device. These portable speakers are smaller in size when compared to a docking station and therefore the sound quality offered by the portable speakers is compromised on account of their size. Although these portable speakers offer users freedom of movement while listening to music and freedom of carrying the speakers when in transit, these portable speakers fail to facilitate a wireless connection of the portable electronic device to the docking station for an improved audio quality when the docking station is available.

Hence, there is a long felt but unresolved need for a wireless communication adaptor and receiver device that can be configured as a standalone portable speaker for playing media received wirelessly from a portable electronic device when a docking station is unavailable or when the user is in transit. Furthermore, there is a need for a wireless communication adaptor and receiver device that provides physical connectivity to a docking station, authenticates the portable electronic device, records voice calls received by the portable electronic device, and provides a portable source of redundant power for charging the portable electronic device.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The wireless communication adaptor and receiver device (WCARD) disclosed herein addresses the above stated need for operating as a standalone portable speaker that plays media, for example, music received wirelessly from a portable electronic device when a docking station is unavailable or when a user is in transit. Furthermore, the WCARD disclosed herein provides physical connectivity to a docking station, authenticates the portable electronic device, records voice calls received by the portable electronic device, and provides a portable source of redundant power for charging the portable electronic device. The WCARD disclosed herein can be remotely controlled and managed by a software application, herein referred to as a “device management application”, on the portable electronic device.

The wireless communication adaptor and receiver device (WCARD) disclosed herein comprises at least one device processor, a communication unit, one or more electrical connectors, an authentication module, an acoustic unit, a recording unit, a non-transitory computer readable storage medium, and a power charging unit. The communication unit is operably coupled to the device processor and wirelessly communicates with a portable electronic device. The electrical connectors, for example, a lightning 8-pin electrical connector, a standard 30-pin electrical connector, etc., connect the WCARD to a docking station and/or the portable electronic device. The authentication module receives an authentication code from the portable electronic device for authenticating the portable electronic device. The acoustic unit plays media comprising, for example, audio data and voice data received wirelessly from the portable electronic device. The recording unit, through a wired connection or a wireless connection, receives and records input data comprising, for example, audio data, voice data, call data, etc., from the portable electronic device via a communication interface. The non-transitory computer readable storage medium is communicatively coupled to the device processor and stores the received input data from the portable electronic device. The power charging unit stores and transmits power to the portable electronic device, for example, via a power cord that connects the WCARD to the portable electronic device.

The wireless communication adaptor and receiver device (WCARD) communicates with a device management system comprising at least one system processor provided on the portable electronic device. The device management system remotely controls and manages the WCARD, for example, for configuring the WCARD to connect to a wireless network, for example, a network implementing Bluetooth® of Bluetooth Sig, Inc., Wi-Fi® of the Wi-Fi Alliance Corporation, etc., for wirelessly transmitting the authentication code and media from the portable electronic device to the WCARD, for wirelessly transmitting input data from the portable electronic device to the recording unit of the WCARD via the communication interface, and for activating the power charging unit of the WCARD for transmitting power from the power charging unit to the portable electronic device.

In one or more embodiments, related systems include but are not limited to circuitry and/or programming for effecting the methods referenced herein; the circuitry and/or programming can be any combination of hardware, software, and/or firmware configured to effect the herein-referenced methods depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates a block diagram of a wireless communication adaptor and receiver device operably connected to a docking station and a portable electronic device.

FIG. 2 exemplarily illustrates a flow diagram for remotely controlling and managing functions of the wireless communication adaptor and receiver device.

FIG. 3 exemplarily illustrates a front perspective view of the wireless communication adaptor and receiver device operably connectable to a docking station.

FIGS. 4A-4B exemplarily illustrate perspective views of the wireless communication adaptor and receiver device, showing electrical connectors of the wireless communication adaptor and receiver device.

FIG. 5 exemplarily illustrates a front perspective view of the wireless communication adaptor and receiver device operably connectable to a docking station, showing an auxiliary port and a power port.

FIG. 6 exemplarily illustrates a rear perspective view of the wireless communication adaptor and receiver device, showing an acoustic unit configured as an integrated speaker.

FIG. 7 illustrates a method for wirelessly playing media received from a portable electronic device on the wireless communication adaptor and receiver device.

### DETAILED DESCRIPTION OF THE INVENTION

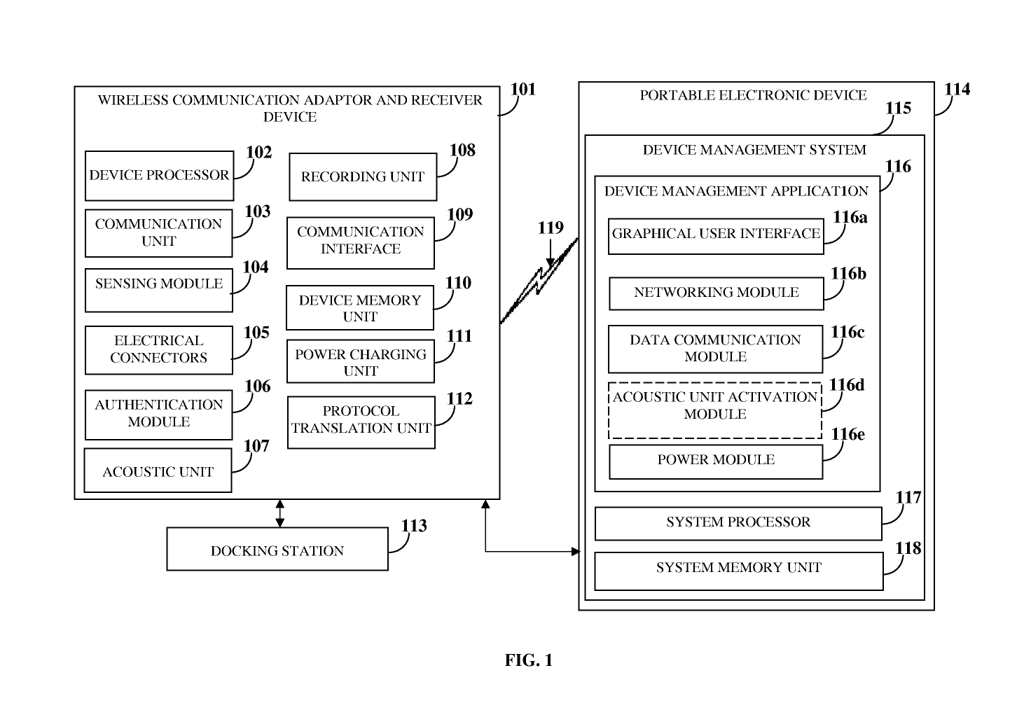

FIG. 1 exemplarily illustrates a block diagram of a wireless communication adaptor and receiver device (WCARD) 101 operably connected to a docking station 113 and a portable electronic device 114. As used herein, “docking station” refers to an electronic device configured to operably connect to another electronic device, for example, the WCARD 101, for facilitating an electrical communication between the WCARD 101 and one or more peripheral devices, for example, battery chargers, etc. In an embodiment, the docking station 113 is a docking station on a radio. The docking station 113 is, for example, a port replicator, a breakout dock, a speaker dock, etc. The docking station 113 enables plugging-in of the WCARD 101 into the docking station 113 to enable the WCARD 101 to communicate with one or more peripheral devices.

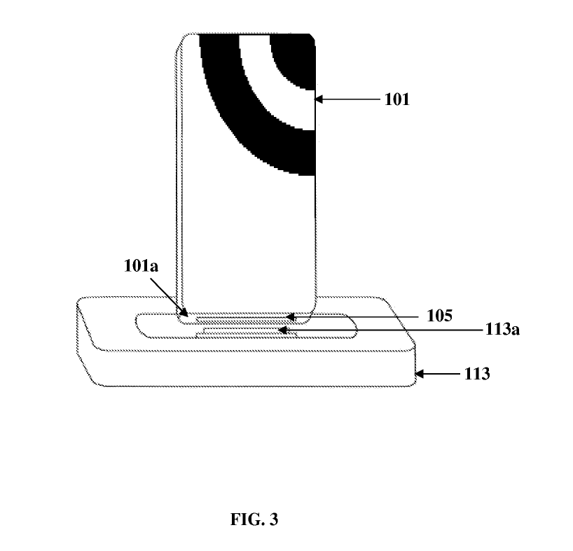

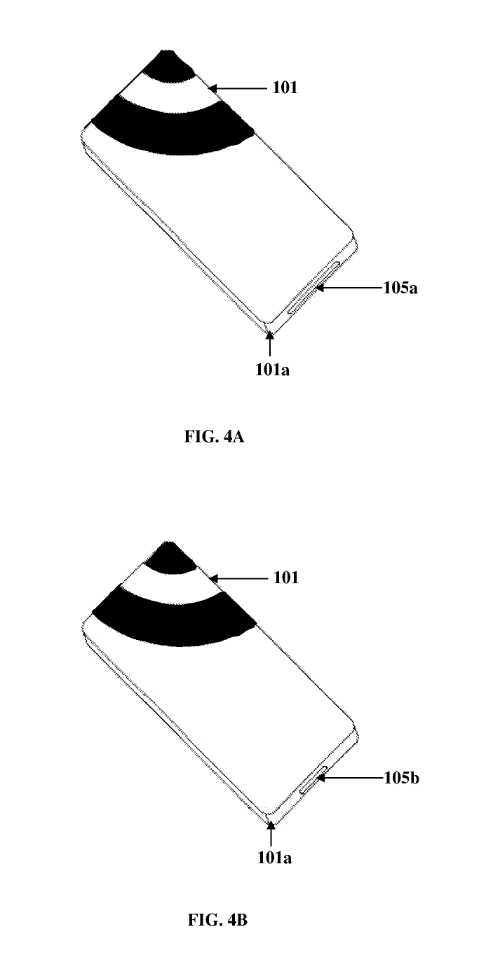

Electronic dockable devices, for example, the wireless communication adaptor and receiver device (WCARD) 101 that can be docked into the docking station 113 are configured with different types of electrical connectors 105, for example, a 30-pin electrical connector 105a exemplarily illustrated in FIG. 4A, or a lightning 8-pin electrical connector 105b exemplarily illustrated in FIG. 4B, power signaling, and uses. Therefore, in an embodiment, the docking station 113 is not standardized and is configured for a specific make and model of the WCARD 101. The docking station 113 is configured with one or more electrical connectors 113a, exemplarily illustrated in FIG. 3, configured to enable a direct plug-in of the WCARD 101 into the docking station 113. As used herein, “direct plug-in” refers to a physical connection between the WCARD 101 and the docking station 113 without use of an adapter cable. In this embodiment, an electrical connector 113a of the docking station 113 complements an electrical connector, for example, 105 of the WCARD 101 as exemplarily illustrated in FIG. 3, to facilitate the direct plug-in of the WCARD 101 into the docking station 113.

The portable electronic device 114 that is operably connected to the wireless communication adaptor and receiver device (WCARD) 101 is, for example, a portable media player such as the iPod® of Apple Inc., a cellular phone such as the iPhone® of Apple Inc., a tablet computing device such as the iPad® of Apple Inc., Kindle® of Amazon Technologies Inc., Nook® of Barnesandnoble.com LLC, etc. Other examples of the portable electronic device 114 are a mobile computer, a mobile phone, a smart phone, a laptop, a personal digital assistant, a wearable device such as Google Glass of Google Inc., Apple Watch of Apple Inc., etc., a touch centric device, a client device, a network enabled computing device, an interactive network enabled communication device, a gaming device, a set top box, a portable television, a disc player such as a Blu-ray Disc® player of Blu-ray Disc Association, a video recorder, an audio recorder, a theater system, any entertainment system, any other suitable computing equipment, combinations of multiple pieces of computing equipment, etc. In an embodiment, the portable electronic device 114 may also be a hybrid device that combines the functionality of multiple devices. The hybrid electronic device comprises, for example, a cellular telephone that includes media player functionality, a gaming device that includes a wireless communication capability, etc.

The wireless communication adaptor and receiver device (WCARD) 101 enables a wireless connection of the portable electronic device 114 to the docking station 113 via a wireless communication link 119 established between the portable electronic device 114 and the WCARD 101. As used herein, “wireless communication link” refers to a logical link used to logically interconnect devices positioned at two or more locations for wireless data transmission. The wireless communication link 119 is established, for example, via a wireless network such as Wi-Fi® of the Wi-Fi Alliance Corporation, a Bluetooth® network of Bluetooth Sig, Inc., etc. The wireless communication link 119 is established using a private network, for example, an intranet or a Wi-Fi® network that is a part of the private network. In an embodiment, the WCARD 101 disclosed herein is configured, for example, as a Bluetooth® adaptor that establishes a Bluetooth® wireless communication link with the portable electronic device 114. When the WCARD 101 is docked on the docking station 113 and a wireless communication is established between the docking station 113 and the user's portable electronic device 114 via the WCARD 101, a user can listen to media, for example, music being played through the iTunes® media player application of Apple Inc., the Pandora® personalized radio application of Pandora Media, Inc., etc., of the user's portable electronic device 114, via the docking station 113, while moving freely anywhere in the user's home. A user may therefore connect the WCARD 101 into the docking station 113 and listen to media stored on the portable electronic device 114 through the docking station 113, while moving freely with the portable electronic device 114, instead of connecting the portable electronic device 114 to the docking station 113.

The wireless communication adaptor and receiver device (WCARD) 101 disclosed herein comprises at least one device processor 102, a communication unit 103, one or more electrical connectors 105, an authentication module 106, an acoustic unit 107, a recording unit 108, a communication interface 109, a non-transitory computer readable storage medium such as a device memory unit 110 communicatively coupled to the device processor 102, and a power charging unit 111. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the device processor 102, except for a transitory, propagating signal. The device processor 102 is configured to execute computer program instructions defined by the modules, for example, the authentication module 106, of the WCARD 101. The WCARD 101 disclosed herein is not limited to employing the device processor 102. The WCARD 101 may also employ a controller or a microcontroller.

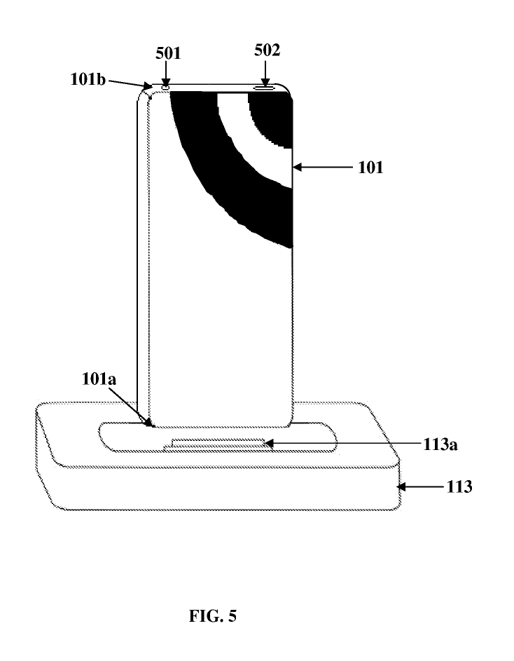

The wireless communication adaptor and receiver device (WCARD) 101 can be connected to the portable electronic device 114 via a Bluetooth® connection or via another wireless connection. In an embodiment, the WCARD 101 is connected to the portable electronic device 114 via the electrical connectors 105. The electrical connectors 105 connect the WCARD 101 to the docking station 113 and/or the portable electronic device 114 physically. The electrical connectors 105 are, for example, multi-pin connectors such as a standard 30-pin electrical connector 105a, a lightning 8-pin electrical connector 105b, etc., as exemplarily illustrated in FIGS. 4A-4B. In an embodiment, the WCARD 101 is physically connected to the portable electronic device 114 using a wired connection comprising, for example, a 30-pin to 30-pin wired connection, an 8-pin to 8-pin wired connection, an 8-pin to 30-pin wired connection, etc., based on the type of an electrical connector (not shown) of the portable electronic device 114 and the electrical connector 105a or 105b of the WCARD 101. In another embodiment, the WCARD 101 comprises an auxiliary port 501 exemplarily illustrated in FIG. 5, for establishing a wired connection with the portable electronic device 114. If the portable electronic device 114 is capable of an auxiliary wired connection, then the WCARD 101 and the portable electronic device 114 can be connected via the auxiliary wired connection through the auxiliary port 501.

The communication unit 103 is operably coupled to the device processor 102. The communication unit 103 is configured to wirelessly communicate with the portable electronic device 114. The communication unit 103 establishes the wireless communication link 119 with the portable electronic device 114 based on a type of connection, for example, a Bluetooth® connection or a Wi-Fi® connection used. In an embodiment, the communication unit 103 is further configured to transmit media received wirelessly from the portable electronic device 114 to a docking station 113 for play by the docking station 113, when the docking station 113 is available. In an embodiment, the communication unit 103 comprises a transceiver, for example, a Bluetooth® transceiver such as the Radio Sector 232 (RS-232) transistor-transistor logic (TTL) transceiver, a wireless local area network (WLAN) transceiver such as 802.11 radio frequency (RF) transceiver, a cellular transceiver such as a time division multiple access (TDMA) transceiver or a code division multiple access (CDMA) transceiver, etc., for receiving input data and/or media from the portable electronic device 114 and for transmitting the received input data and/or the received media to the docking station 113. In another embodiment, the communication unit 103 comprises a transmitter and a receiver. The receiver receives input data and/or media from the portable electronic device 114. The transmitter transmits the received input data and/or the received media to the docking station 113 via a physical connection established by the electrical connector 105 of the wireless communication adaptor and receiver device (WCARD) 101 and the electrical connector 113a of the docking station 113 exemplarily illustrated in FIG. 3. In an embodiment, if the docking station 113 is capable of wireless communication, the communication unit 103 transmits the input data and/or media to the docking station 113 wirelessly via the wireless network using a wireless streaming technology, for example, AirPlay® of Apple Inc. AirPlay® allows wireless streaming of media comprising, for example, audio data, video data, image data, etc., along with related metadata of the communicating devices, for example, the WCARD 101 and the docking station 113. In an embodiment, the wireless streaming technology is used to establish the wireless communication link 119 between the portable electronic device 114 and the WCARD 101 for data and media transmission. In this embodiment, the portable electronic device 114 wirelessly streams the input data and/or the media to the WCARD 101 for reception by the communication unit 103 of the WCARD 101.

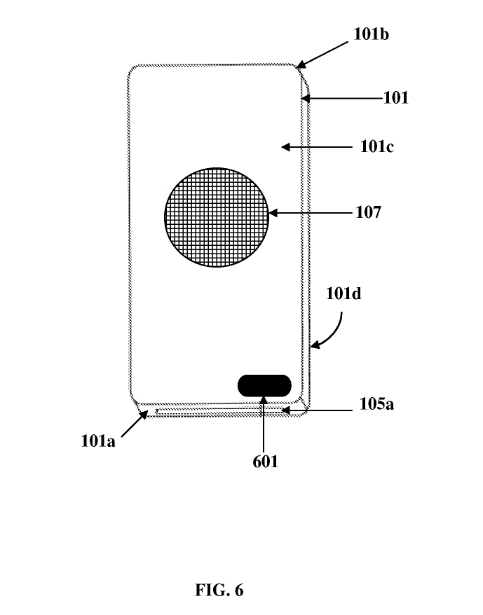

The authentication module 106 of the wireless communication adaptor and receiver device (WCARD) 101 receives an authentication code, for example, a password or a passcode from the portable electronic device 114 for authenticating the portable electronic device 114. In an embodiment, the authentication module 106 of the WCARD 101 docked on the docking station 113 authenticates the portable electronic device 114 prior to establishing a wireless communication between the portable electronic device 114 and the docking station 113. The authentication module 106 also receives a passcode from the portable electronic device 114 to authenticate and pair the WCARD 101 with the portable electronic device 114 via the Bluetooth® connection using a pairing button 601 exemplarily illustrated in FIG. 6.

Consider an example where a user is trying to connect his/her portable electronic device 114 to the docking station 113 through an external wireless network that is outside his/her home, using the wireless communication adaptor and receiver device (WCARD) 101. The external wireless network is password protected or requires an authentication code or a passcode for access. The user enters the authentication code through a graphical user interface (GUI) 116a accessible on his/her portable electronic device 114. The portable electronic device 114 transmits the entered authentication code to the WCARD 101, for example, via the Bluetooth® connection between the portable electronic device 114 and the WCARD 101. The authentication module 106 of the WCARD 101 receives the authentication code for access to the external wireless network from the portable electronic device 114 and authenticates the portable electronic device 114 to connect the portable electronic device 114 to the docking station 113 via the external wireless network. When a user wants to connect his/her portable electronic device 114 to the WCARD 101 over an external wireless network, an additional authentication code or a passcode is required to establish the connection between the portable electronic device 114 and the WCARD 101 to prevent unauthorized users using the external wireless network from accessing the WCARD 101. The authentication module 106 of the WCARD 101 receives the additional authentication code from the portable electronic device 114 and authenticates the portable electronic device 114.

The acoustic unit 107 plays media received wirelessly from the portable electronic device 114. The media comprises, for example, audio data, voice data, etc. In an embodiment, the acoustic unit 107 is configured as one or more speakers integrated within the wireless communication adaptor and receiver device (WCARD) 101 as exemplarily illustrated in FIG. 6. In this embodiment, the acoustic unit 107 allows the WCARD 101 to be used as a wireless portable speaker that can be wirelessly connected to the portable electronic device 114 via the wireless network, for example, a Wi-Fi® network, when the wireless network exists, or can be paired with the portable electronic device 114 via a Bluetooth® connection when the wireless network does not exist. In another embodiment, the acoustic unit 107 plays media received from the portable electronic device 114 via the auxiliary wired connection made with the portable electronic device 114 through the auxiliary port 501 of the WCARD 101 exemplarily illustrated in FIG. 5. A user may achieve ease of movement by using the portable speaker configuration of the WCARD 101 when the WCARD 101 is not connected to the docking station 113 such as a docking station of a radio. Another example of ease of movement facilitated by the WCARD 101 is when a user is at a beach listening to music that is received wirelessly by the WCARD 101 from the user's portable electronic device 114 via a Bluetooth® connection or via the auxiliary wired connection through the auxiliary port 501 of the WCARD 101, and played through the integrated speakers of the WCARD 101. In this example, the user can listen to music being played through the iTunes® media player application of Apple Inc., the Pandora® personalized radio application of Pandora Media, Inc., etc., of the user's portable electronic device 114, through the integrated speakers of the WCARD 101, while moving freely at the beach.

In an embodiment, the wireless communication adaptor and receiver device (WCARD) 101 further comprises a sensing module 104 in operable communication with the communication unit 103. The sensing module 104 determines availability of a docking station 113 based on a response to a status request transmitted by the communication unit 103 to the docking station 113. In an embodiment, the communication unit 103 transmits the status request to the docking station 113. Ensuring the availability of the docking station 113 facilitates playing of the media received wirelessly from the portable electronic device 114 by the docking station 113 without interruption. In this embodiment, the docking station 113 receives and responds to the periodically transmitted status request with a feedback signal comprising the availability status of the docking station 113. As used herein, “availability status” refers to a status of the docking station 113 that indicates whether the docking station 113 is available or unavailable for playing the wirelessly received media. The docking station 113 is considered to be unavailable when the docking station 113 is, for example, powered off, low on battery charge, out of order, etc. The sensing module 104 receives the feedback signal from the docking station 113 and determines the availability of the docking station 113 from the received feedback signal.

In an embodiment, after the communication unit 103 transmits the status request to the docking station 113, the sensing module 104 waits for a predefined time period to receive a feedback signal from the docking station 113. In this embodiment, if the sensing module 104 fails to receive the feedback signal in the predefined time period, the sensing module 104 determines the availability status of the docking station 113 as unavailable. Periodic transmission of the status request enables the wireless communication adaptor and receiver device (WCARD) 101 and the docking station 113 to establish a device handshake before transmission of the media from the portable electronic device 114 to the docking station 113 via the WCARD 101. In an embodiment, the communication unit 103 transmits the status request to the docking station 113 when the portable electronic device 114 attempts to establish a wireless communication or a wired connection with the WCARD 101. Thus, the WCARD 101 automatically determines, that is, senses an availability status of the docking station 113 when the portable electronic device 114 pairs with the WCARD 101, for example, via a Bluetooth® connection, or wirelessly connects with the WCARD 101 via a Wi-Fi® network, or physically connects to the WCARD 101 via the auxiliary wired connection, for playing the media received from the portable electronic device 114 on the docking station 113. In an embodiment, the WCARD 101 is used as a wireless portable speaker for playing the media wirelessly received from the portable electronic device 114, when the docking station 113 is unavailable.

In another embodiment, the acoustic unit 107 of the wireless communication adaptor and receiver device (WCARD) 101 is configured as a microphone for receiving media and/or input data comprising, for example, audio data, voice data, and/or call data from the user for establishing a duplex communication. In an embodiment, the duplex communication established by the WCARD 101 comprises receiving input data from the user by the recording unit 108 of the WCARD 101 via the acoustic unit 107 that is configured as a microphone and playing back the received input data through the acoustic unit 107 that is also configured as a speaker. For example, when the user is on a phone call through the portable electronic device 114, the user can talk into the acoustic unit 107 that is configured as a microphone to establish a two-way conversation, while the recording unit 108 records the input data, that is, the user's voice in a recording mode for playback by the acoustic unit 107 that is configured as a speaker.

In the recording mode, the recording unit 108 of the wireless communication adaptor and receiver device (WCARD) 101 receives and records the input data comprising, for example, audio data, voice data, call data, etc., from the portable electronic device 114 via the communication interface 109. In an embodiment, the recording unit 108 wirelessly receives and records the input data from the portable electronic device 114 through the established wireless communication link 119 between the WCARD 101 and the portable electronic device 114. In another embodiment, the recording unit 108 receives and records the input data from the portable electronic device 114 via the auxiliary wired connection made with the portable electronic device 114 through the auxiliary port 501 of the WCARD 101 exemplarily illustrated in FIG. 5. The communication interface 109 through which the WCARD 101 receives media and/or input data is, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a personal area network (PAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. In an embodiment, the communication interface 109 is a network interface card also referred to as a line card. In an embodiment, the recording unit 108 records only audio data, voice data, or the call data. Thus, the acoustic unit 107 is configured as a speaker, a microphone, or a combination thereof, to receive and playback the input data for establishing a duplex communication.

The device memory unit 110 of the wireless communication adaptor and receiver device (WCARD) 101 stores the received input data from the portable electronic device 114. The device memory unit 110 is any storage area or medium that can be used for storing data. In an embodiment, the device memory unit 110 can also be a location on a file system. The device memory unit 110 is, for example, a random access memory (RAM) or another type of dynamic storage device that stores information and instructions for execution by the device processor 102. The device memory unit 110 also stores the computer program instructions defined by the modules, for example, the authentication module 106, of the WCARD 101. The device memory unit 110 also stores temporary variables, static information, and other intermediate information used during execution of the computer program instructions by the device processor 102.

In an embodiment, the recording unit 108 and the device memory unit 110 enable the wireless communication adaptor and receiver device (WCARD) 101 to be configured, for example, as an answering machine for voice and/or call recording purposes. Consider an example where a user's portable electronic device 114 is connected to the WCARD 101 wirelessly, or via a wired connection, for example, via the auxiliary wired connection made with the WCARD 101 through the auxiliary port 501 of the WCARD 101 exemplarily illustrated in FIG. 5, for using the WCARD 101 as a portable speaker, and via the electrical connectors 105 for charging the portable electronic device 114. The user receives a call on his/her portable electronic device 114, while listening to music through the acoustic unit 107 of the WCARD 101 that is configured as a speaker. The user does not wish to discontinue playing music or answer the call while the portable electronic device 114 is being charged. Therefore, the user does not answer the call. The recording unit 108 receives and records the voice data and/or the call data associated with the unanswered call from the portable electronic device 114 via the communication interface 109 wirelessly or through the wired connection. The device memory unit 110 stores the received voice data and/or call data. In an embodiment, the acoustic unit 107 of the WCARD 101 that is configured as a speaker plays back the recorded voice data and/or call data. The WCARD 101 therefore operates as an answering machine.

The power charging unit 111 of the wireless communication adaptor and receiver device (WCARD) 101 stores power received, for example, from the docking station 113 and transmits the stored power to the portable electronic device 114, for example, through a wired connection via a power cord that connects the WCARD 101 to the portable electronic device 114 via a power port 502 of the WCARD 101 exemplarily illustrated in FIG. 5. The WCARD 101 provides a portable source of redundant power to the portable electronic device 114. In an embodiment, the WCARD 101 further comprises a protocol translation unit 112. The protocol translation unit 112 translates communication protocols of the portable electronic device 114 and the docking station 113 for establishing a wireless communication between the portable electronic device 114 and the docking station 113. The communication protocols comprise, for example, a transmission control protocol (TCP), an internet protocol (IP), the Institute of Electrical and Electronics Engineers (IEEE) 802.11 protocol, Bluetooth® communication protocols, a file transfer protocol (FTP), etc. The protocol translation unit 112 translates a first communication protocol that the portable electronic device 114 implements to a second communication protocol that the WCARD 101 implements. The second communication protocol is a communication protocol that the communication interface 109 of the WCARD 101 implements. The protocol translation unit 112 translates the second communication protocol that the WCARD 101 implements to a third communication protocol that the docking station 113 implements.

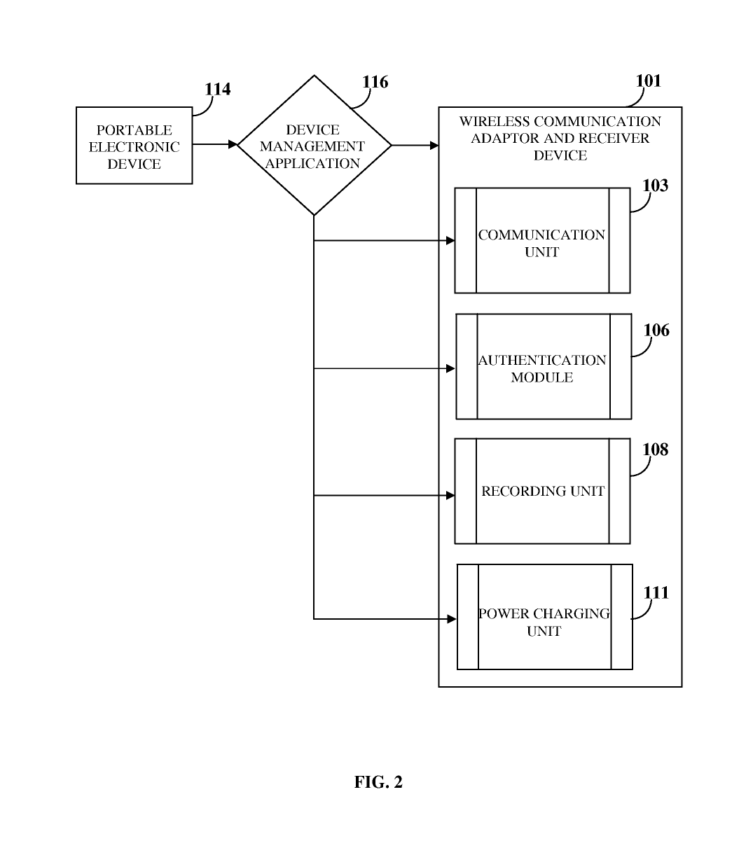

The wireless communication adaptor and receiver device (WCARD) 101 communicates with a device management system 115 comprising at least one system processor 117 provided on the portable electronic device 114. The system processor 117 executes computer program instructions defined by modules, for example, 116b, 116c, 116d, 116e, etc., of the device management system 115 for remotely controlling and managing functions of the WCARD 101 as disclosed in the detailed description of FIG. 2. The device management system 115 disclosed herein is not limited to a particular computer system platform, system processor 117, operating system, or network. One or more aspects of the device management system 115 may be distributed among one or more computer systems, for example, servers configured to provide one or more services to one or more client computers, or to perform a complete task in a distributed system. For example, one or more aspects of the device management system 115 may be performed on a client-server system that comprises components distributed among one or more server systems that perform multiple functions according to various embodiments. These components comprise, for example, executable, intermediate, or interpreted code, which communicate over a network using a communication protocol. The device management system 115 is not limited to be executable on any particular system or group of systems, and is not limited to any particular distributed architecture, network, or communication protocol.

As exemplarily illustrated in FIG. 1, the device management system 115 comprises a device management application 116, the system processor 117, and the system memory unit 118. The device management application 116 remotely controls and manages the wireless communication adaptor and receiver device (WCARD) 101. The device management application 116 comprises a graphical user interface (GUI) 116a, a networking module 116b, a data communication module 116c, and a power module 116d. The GUI 116a receives inputs provided by a user through the device management application 116 on the portable electronic device 114 for remotely controlling and managing the functions of the WCARD 101. The GUI 116a is, for example, a webpage of a website hosted by the device management system 115, an online web interface, a web based downloadable application interface, a mobile based downloadable application interface, etc. The GUI 116a displays, for example, information, display interfaces, user interface elements such as text fields, checkboxes, text boxes, windows, activation buttons, etc., for allowing a user to provide inputs to configure network settings for establishing the wireless communication link 119 with the WCARD 101, to activate a voice recording mode, a power charging mode, a speaker mode, etc.

The networking module 116b of the device management application 116 configures the wireless communication adaptor and receiver device (WCARD) 101 to connect to a wireless network, for example, Wi-Fi® network. The data communication module 116c of the device management application 116 wirelessly transmits the authentication code from the portable electronic device 114 to the WCARD 101 for authentication of the portable electronic device 114 by the authentication module 106 of the WCARD 101. Furthermore, the data communication module 116c wirelessly transmits or streams media from the portable electronic device 114 to the WCARD 101, for example, via the established wireless communication link 119. In an embodiment, the device management application 116 further comprises an acoustic unit activation module 116d for activating the acoustic unit 107 of the WCARD 101 and triggering the data communication module 116c of the device management application 116 to wirelessly transmit the media to the acoustic unit 107 of the WCARD 101. Furthermore, the data communication module 116c transmits the input data from the portable electronic device 114 to the recording unit 108 of the WCARD 101 via the communication interface 109. The power module 116e of the device management application 116 activates the power charging unit 111 of the WCARD 101 for transmission of power from the power charging unit 111 to the portable electronic device 114.

In an embodiment, the device management application 116 is downloadable on the portable electronic device 114, for example, from an application store. In another embodiment, the device management application 116 is implemented on a website hosted on a server or a network of servers and is accessible to the portable electronic device 114 via a network, for example, the internet, a wireless network, a Wi-Fi® network, a mobile telecommunication network such as a third generation (3G) mobile communication network, a fourth generation (4G) mobile communication network, a long-term evolution (LTE) mobile communication network, etc., or a network formed from any combination of these networks.

The system processor 117 of the device management system 115 executes the device management application 116, for example, the modules 116b, 116c, 116d, 116e, etc., of the device management application 116. The system processor 117 retrieves computer program instructions defined by the networking module 116b, the data communication module 116c, the acoustic unit activation module 116d, the power module 116e, etc., of the device management application 116 for performing respective functions disclosed above. The system processor 117 retrieves instructions for executing the modules, for example, 116b, 116c, 116d, 116e, etc., from the system memory unit 118. A program counter determines the location of the instructions in the system memory unit 118. The program counter stores a number that identifies the current position in the program of each of the modules, for example, 116b, 116c, 116d, 116e, etc., of the device management application 116. The computer program instructions fetched by the system processor 117 from the system memory unit 118 after being processed are decoded. The computer program instructions are stored in an instruction register in the system processor 117. After processing and decoding, the system processor 117 executes the computer program instructions, thereby performing one or more processes defined by those computer program instructions. At the time of execution, the computer program instructions stored in the instruction register are examined to determine the operations to be performed. The operations comprise arithmetic operations and logic operations. The system processor 117 then performs the specified operations. The device management system 115 disclosed herein is not limited to employing the system processor 117. The device management system 115 may also employ a controller or a microcontroller.

The system memory unit 118 is used for storing programs, application, and data. For example, the networking module 116b, the data communication module 116c, the acoustic unit activation module 116d, the power module 116e, etc., of the device management application 116 are stored in the system memory unit 118. The system memory unit 118 is any storage area or medium that can be used for storing data. In an embodiment, the system memory unit 118 can also be a location on a file system. The system memory unit 118 is, for example, a random access memory (RAM) or another type of dynamic storage device that stores information and instructions for execution by the system processor 117. The system memory unit 118 also stores temporary variables, static information, and other intermediate information used during execution of the computer program instructions by the system processor 117.

The system processor 117 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The device management system 115 employs the operating system for performing multiple tasks. The operating system is responsible for management and coordination of activities and sharing of resources of the device management system 115. The operating system further manages security of the device management system 115, peripheral devices connected to the device management system 115, and network connections. The operating system employed on the device management system 115 recognizes, for example, inputs provided by the users using input devices, the output display, files, and directories stored locally on a fixed media drive. The operating system on the device management system 115 executes different programs using the system processor 117. The system processor 117 and the operating system together define a computer system for which application programs in high level programming languages are written.

The operating system performs multiple routines for performing a number of tasks required to assign memory for execution of the modules, for example, 116b, 116c, 116d, 116e, etc., of the device management application 116. The tasks performed by the operating system comprise, for example, assigning memory to the modules, for example, 116b, 116c, 116d, 116e, etc., of the device management application 116, and to data used by the device management application 116, moving data between the system memory unit 118 and disk units, and handling input/output operations. The operating system performs the tasks on request by the operations and after performing the tasks, the operating system transfers the execution control back to the system processor 117. The system processor 117 continues the execution to obtain one or more outputs. The outputs of the execution of the modules, for example, 116b, 116c, 116d, 116e, etc., of the device management application 116 are displayed to the user on the graphical user interface (GUI) 116a.

For purposes of illustration, the detailed description refers to the device management system 115 being run locally as a single computer system; however the scope of the device management system 115 disclosed herein is not limited to being run locally as a single computer system via the operating system and the system processor 117, but may be extended to run remotely over a network, for example, the internet by employing a web browser and a remote server, a mobile phone, or other electronic devices. One or more portions of the device management system 115 may be distributed across one or more computer systems (not shown) coupled to the network.

The device processor 102 of the wireless communication adaptor and receiver device (WCARD) 101 and the system processor 117 of the device management system 115 on the portable electronic device 114, each refer to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The device processor 102 and the system processor 117 may each also be implemented as a processor set comprising, for example, a general purpose microprocessor and a math or graphics co-processor. The device processor 102 and the system processor 117 are selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc.

FIG. 2 exemplarily illustrates a flow diagram for remotely controlling and managing functions of the wireless communication adaptor and receiver device (WCARD) 101. As exemplarily illustrated in FIG. 2, the device management application 116 installed on the portable electronic device 114 remotely controls and manages the communication unit 103, the authentication module 106, the recording unit 108, and the power charging unit 111 of the WCARD 101, for example, for configuring the communication unit 103 to connect to a wireless network, for wirelessly transmitting an authentication code from the portable electronic device 114 to the authentication module 106 for authenticating the portable electronic device 114, for wirelessly transmitting input data from the portable electronic device 114 to the recording unit 108, and for activating the power charging unit 111 for transmitting power from the power charging unit 111 to the portable electronic device 114.

The device management application 116 supports configuring of the wireless communication adaptor and receiver device (WCARD) 101 for connection to a wireless network and for voice and/or call recording. Consider an example where a user is trying to connect the WCARD 101 to a wireless network, for example, the user's home network that implements Wi-Fi® using the device management application 116 installed in the user's portable electronic device 114 such as a touch screen enabled mobile phone. In this example, for configuring the wireless network on the WCARD 101, the user first pairs the WCARD 101 with the user's portable electronic device 114 via Bluetooth®. After pairing the WCARD 101 with the portable electronic device 114, the user invokes the device management application 116 that supports the WCARD 101 on the portable electronic device 114 to configure the WCARD 101 for connection to the wireless network.

The device management application 116 displays a settings menu to the user on the graphical user interface (GUI) 116a of the device management application 116 exemplarily illustrated in FIG. 1. The user taps on the settings menu on the GUI 116a to access a wireless and network settings option and selects the Wi-Fi® option. If the Wi-Fi® option is switched off, then the user taps on an on/off slider button provided on a display window to switch on the Wi-Fi® option. The device management application 116 displays a list of available Wi-Fi® connections or Wi-Fi® networks on the GUI 116a to the user. The user then taps on the Wi-Fi® network that the user wishes to join on the GUI 116a. If the Wi-Fi® network requires an authentication code, the device management application 116 prompts the user to enter the authentication code. The user enters an authentication code, for example, a password for the selected wireless network and clicks on a join button provided on the display window. The device management application 116 matches the entered authentication code with the password of the selected wireless network and connects the wireless communication adaptor and receiver device (WCARD) 101 to the Wi-Fi® network on finding a match. The device management application 116 displays a checkmark next to an icon of the Wi-Fi® network joined and displays the Wi-Fi® icon in the status bar of the portable electronic device 114.

Consider another example where a user is trying to connect his/her portable electronic device 114 to the wireless communication adaptor and receiver device (WCARD) 101 through an external wireless network outside the user's home network, for example, a hotel's wireless network, and the user does not wish to use a Bluetooth® connection between the portable electronic device 114 and the WCARD 101 for wirelessly playing media. Also, consider that the user does not wish to use an auxiliary wired connection to connect the WCARD 101 to the portable electronic device 114 for playing media. In this example, the WCARD 101 is directly plugged-in to a docking station 113 exemplarily illustrated in FIG. 1, in a hotel room and is connected to the external wireless network. The device management application 116 uses an additional layer of security which requires the user to provide an additional authentication code to synchronize the WCARD 101 with the portable electronic device 114 after locating the WCARD 101 on the external wireless network. To connect the portable electronic device 114 to the WCARD 101 through the external wireless network, the user invokes the device management application 116 on the user's portable electronic device 114 and first connects the portable electronic device 114 to the external wireless network by selecting the external wireless network displayed on the graphical user interface (GUI) 116a and entering a password for the external wireless network on the GUI 116a. The user using his/her portable electronic device 114 searches for devices that are available to connect to on the external wireless network. On locating the WCARD 101, the user tries to wirelessly connect the portable electronic device 114 to the WCARD 101. The device management application 116 displays a pop up window on the user's portable electronic device 114 where the user enters the additional authentication code required for passing the additional layer of security. The device management application 116 wirelessly transmits the authentication code to the WCARD 101 via the external wireless network. The authentication module 106 of the WCARD 101 authenticates the portable electronic device 114 using the authentication code to synchronize the WCARD 101 with the portable electronic device 114 on the external wireless network. After synchronizing with the WCARD 101, the device management application 116 on the portable electronic device 114 wirelessly transmits media from the portable electronic device 114 to the WCARD 101 for playing via the docking station 113. In an embodiment, to enable the WCARD 101 to be connected to the external wireless network, the device management application 116 on the portable electronic device 114 configures the WCARD 101, for example, via a Bluetooth® connection, to connect to the external wireless network first and then requests the user to enter the password for the external wireless network on the GUI 116a.

The wireless communication adaptor and receiver device (WCARD) 101 provides an audio or voice recording feature in communication with the device management application 116 that controls the WCARD 101. After enabling the audio or voice recording feature via the device management application 116, the recording unit 108 of the WCARD 101, through a wired connection or a wireless connection, receives and records input data from the portable electronic device 114 via the communication interface 109. The device management application 116 provides different configuration options via a settings menu on the graphical user interface (GUI) 116a of the device management application 116. For example, the device management application 116 provides a voice recording mode option in the settings menu to configure voice recording between the WCARD 101 and the portable electronic device 114. The user can tap an on/off slider button on the GUI 116a to select or deselect the voice recording mode option.

The recorded voice and/or call data is stored in the device memory unit 110 of the wireless communication adaptor and receiver device (WCARD) 101 exemplarily illustrated in FIG. 1. The portable electronic device 114 accesses the input data stored in the device memory unit 110 via the device management application 116. A user may view the recorded voice data and/or call data stored in the device memory unit 110 of the WCARD 101 as stored media on the graphical user interface (GUI) 116a of the device management application 116 on the portable electronic device 114. The device management application 116 receives user inputs via the GUI 116a for controlling playback of the recorded voice and/or call data by the acoustic unit 107 of the WCARD 101 exemplarily illustrated in FIG. 1. The user can, for example, play, pause, resume, seek, replay, etc., the recorded voice and/or call data via the GUI 116a of the device management application 116 on the portable electronic device 114.

In another example, the device management application 116 provides a battery charger mode option in the settings menu on the graphical user interface (GUI) 116a of the device management application 116 for activating the power charging unit 111 of the wireless communication adaptor and receiver device (WCARD) 101 and configuring the WCARD 101 as a portable battery charger for charging the portable electronic device 114, for example, via the electrical connectors 105a and 105b exemplarily illustrated in FIGS. 4A-4B, or via a power cord connected from the portable electronic device 114 to the power port 502 of the WCARD 101 exemplarily illustrated in FIG. 5. The user can tap the on/off slider button on the GUI 116a of the device management application 116 to select or deselect the battery charger mode option. On receiving an indication of a selection or a deselection of the battery charger mode option, the device management application 116 activates or deactivates the power charging unit 111 of the WCARD 101. In an embodiment, the device management application 116 monitors the power charging, generates a notification indicating completion of power charging, and renders the generated notification on the GUI 116a. On completion of the power charging, the device management application 116 deactivates the power charging unit 111 of the WCARD 101.

In another example, the device management application 116 provides a speaker mode option in the settings menu on the graphical user interface (GUI) 116a of the device management application 116 for configuring the wireless communication adaptor and receiver device (WCARD) 101 as a portable speaker when the docking station 113 is unavailable. The user can tap the on/off slider button on the GUI 116a to select or deselect the speaker mode option. In an embodiment, on receiving an indication of a selection or a deselection of the speaker mode option, the device management application 116 activates or deactivates the acoustic unit 107 of the WCARD 101.

FIG. 3 exemplarily illustrates a front perspective view of the wireless communication adaptor and receiver device (WCARD) 101 operably connectable to a docking station 113. As exemplarily illustrated in FIG. 3, an electrical connector 105 is configured as a female electrical connector, for example, a lightning 8-pin female electrical connector, a 30-pin female electrical connector, etc., on a bottom surface 101a of the WCARD 101. This electrical connector 105 physically connects to an electrical connector 113a configured as a male electrical connector, for example, a lightning 8-pin male electrical connector, a 30-pin male electrical connector, etc., of the docking station 113. In an embodiment, the electrical connector 105 is configured as a male electrical connector and the electrical connector 113a is configured as a female electrical connector. If both the electrical connectors 105 and 113a are of a female type or a male type or have different pin configurations, then the WCARD 101 can be physically connected to the docking station 113 using an adapter cable, for example, with a lightning 8-pin to 8-pin male adapter, a 30-pin to 30-pin male adapter, a lightning 8-pin to 8-pin female adapter, a 30-pin to 30-pin female adapter, a lightning 8-pin to 30-pin male adapter, a lightning 8-pin to 30-pin female adapter, and any combinations thereof.

FIGS. 4A-4B exemplarily illustrate perspective views of the wireless communication adaptor and receiver device (WCARD) 101, showing electrical connectors 105a and 105b of the WCARD 101. The electrical connectors 105a and 105b connect the WCARD 101 to the docking station 113 exemplarily illustrated in FIG. 3, and/or to the portable electronic device 114 exemplarily illustrated in FIG. 1. FIG. 4A exemplarily illustrates the WCARD 101 with a 30-pin electrical connector 105a. FIG. 4B exemplarily illustrates the WCARD 101 with a lightning 8-pin electrical connector 105b. In an embodiment, the WCARD 101 can be directly connected to the portable electronic device 114 using the electrical connectors 105a and 105b for using the WCARD 101 as a portable speaker. In another embodiment, the WCARD 101 can be directly connected to the docking station 113 using the electrical connectors 105a and 105b for playing media through the docking station 113. Consider an example where the user is travelling and is staying at a hotel. If the hotel provides a docking station 113 on a radio with an electrical connector 113a exemplarily illustrated in FIG. 3, that supports a standard 30-pin electrical connection or a lightning 8-pin electrical connection, then the user can directly connect the WCARD 101 to the docking station 113 using the electrical connectors 105a and 105b to play media stored on the user's portable electronic device 114 through the docking station 113.

FIG. 5 exemplarily illustrates a front perspective view of the wireless communication adaptor and receiver device (WCARD) 101 operably connected to a docking station 113, showing an auxiliary port 501 and a power port 502. As exemplarily illustrated in FIG. 5, the auxiliary port 501 and the power port 502 are configured on a top surface 101b of the WCARD 101. The auxiliary port 501 of the WCARD 101 is configured to establish a wired communication with the portable electronic device 114. The WCARD 101 connects to the portable electronic device 114, exemplarily illustrated in FIG. 1, via an auxiliary wired connection through the auxiliary port 501. An electrical connector (not shown) positioned at an opposing end of a wire cable (not shown) which is connected to the portable electronic device 114, is inserted into the auxiliary port 501 of the WCARD 101 to establish the wired communication between the WCARD 101 and the portable electronic device 114. The power port 502 enables the WCARD 101 to be used as a portable battery charger. In an embodiment, the power port 502 is configured to receive an electrical connector (not shown). In this embodiment, the portable battery charger configuration of the WCARD 101 requires, for example, a 30-pin to 30-pin wired connection, an 8-pin to 8-pin wired connection, or an 8-pin to 30-pin wired connection, depending upon the type of connection between the portable electronic device 114 and the WCARD 101. In another embodiment, the power port 502 is configured as a universal serial bus (USB) port. In this embodiment, the portable battery charger configuration of the WCARD 101 requires, for example, a 30-pin to USB wired connection or an 8-pin to USB wired connection, based on the type of electrical connectors (not shown) of the portable electronic device 114.

FIG. 6 exemplarily illustrates a rear perspective view of the wireless communication adaptor and receiver device (WCARD) 101, showing the acoustic unit 107 configured as an integrated speaker. As exemplarily illustrated in FIG. 6, the acoustic unit 107 configured as an integrated speaker is positioned on a rear surface 101c of the WCARD 101. In an embodiment, the acoustic unit 107 configured as an integrated speaker is positioned on a front surface 101d of the WCARD 101. In another embodiment, acoustic units 107 configured as integrated speakers are positioned on the front surface 101d and the rear surface 101c of the WCARD 101. The acoustic unit 107 plays media received from the portable electronic device 114 via a wired connection or a wireless connection. A pairing button 601 is positioned on the rear surface 101c of the WCARD 101 as exemplarily illustrated in FIG. 6. Activation of the pairing button 601 enables the WCARD 101 to establish a Bluetooth® connection with the portable electronic device 114.

Consider an example where a user is trying to configure a Bluetooth® connection between the wireless communication adaptor and receiver device (WCARD) 101 and the user's portable electronic device 114. Initially, the user ensures that both the portable electronic device 114 and the WCARD 101 are charged for the pairing process. The user activates Bluetooth® on the user's portable electronic device 114 by accessing the settings menu and activating the Bluetooth® option on the portable electronic device 114. When the user switches the WCARD 101 on, a light (not shown) on the WCARD 101 blinks once. To pair the WCARD 101 to the user's portable electronic device 114, the user presses and holds the pairing button 601 on the WCARD 101 exemplarily illustrated in FIG. 6, for a time period, for example, from about 5 seconds to about 10 seconds. During this time period, the WCARD 101 identifies the user's portable electronic device 114 and attempts to link to the portable electronic device 114. While searching for the user's portable electronic device 114, the light on the WCARD 101 blinks, for example, in a series of three. The user has to keep holding the pairing button 601 until the light stops blinking and becomes solid. The solid light indicates successful pairing between the WCARD 101 and the portable electronic device 114. The user then accesses the Bluetooth® settings of the portable electronic device 114 and scans for paired devices. The portable electronic device 114 displays an icon of the WCARD 101 in the paired devices list. The user selects the paired WCARD 101 and allows the WCARD 101 to establish a wireless communication link 119 exemplarily illustrated in FIG. 1, to the portable electronic device 114. If the user is prompted for a password or an authentication code, the user enters a passcode, for example, 00000 on the graphical user interface (GUI) 116a exemplarily illustrated in FIG. 1. Once the user's portable electronic device 114 establishes the wireless communication link 119 to the WCARD 101, the user receives a message notification indicating that the pairing has been successfully completed. The user can then use the WCARD 101 with the portable electronic device 114, for example, for playing media received wirelessly from the portable electronic device 114, for recording voice data and/or call data, charging the portable electronic device 114, etc.

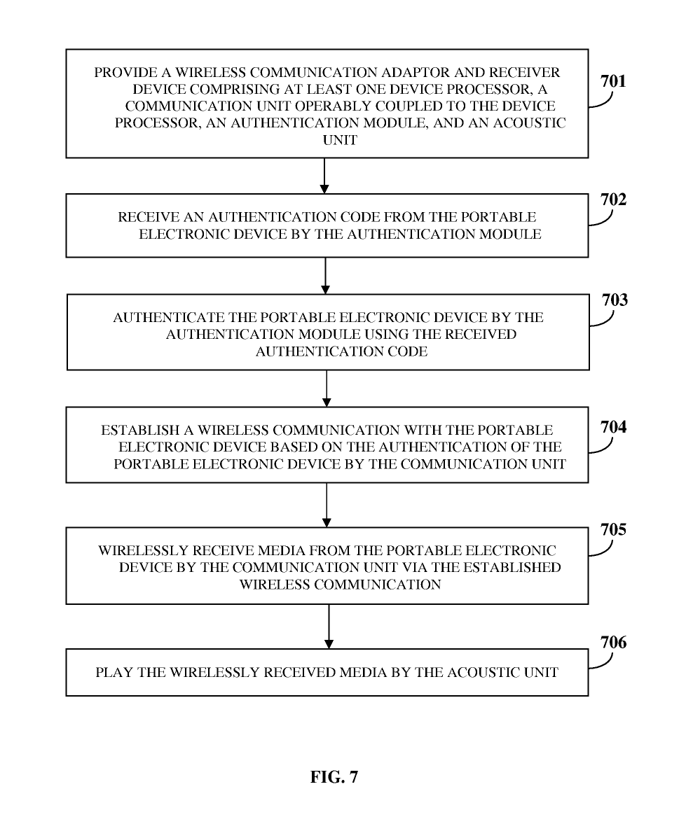

FIG. 7 exemplarily illustrates a method for wirelessly playing media received from a portable electronic device 114 on the wireless communication adaptor and receiver device (WCARD) 101. In the method disclosed herein, the WCARD 101 comprising the device processor 102, the communication unit 103 operably coupled to the device processor 102, the authentication module 106, and the acoustic unit 107 as exemplarily illustrated in FIG. 1, is provided 701. When a user attempts to connect his/her portable electronic device 114 to the WCARD 101, for example, via a Bluetooth® connection, or to the WCARD 101 that is configured on a wireless network external to the user's home network, the authentication module 106 of the WCARD 101 requests for an authentication code. The authentication module 106 receives 702 the authentication code provided by the user from the portable electronic device 114. The authentication module 106 authenticates 703 the portable electronic device 114 by matching the received authentication code with set of predefined passwords or passcodes stored in the WCARD 101. In another embodiment, the authentication module 106 authenticates the portable electronic device 114 by matching the received authentication code with a predefined password or a predefined passcode such as a passcode used for Bluetooth® pairing or a password of the external wireless network. In an embodiment, the authentication module 106 transmits an authentication error notification to the portable electronic device 114 when the authentication code fails the authentication. The communication unit 103 of the WCARD 101 establishes 704 a wireless communication with the portable electronic device 114 based on the authentication of the portable electronic device 114. If the authentication is successful, the communication unit 103 establishes the wireless communication with the portable electronic device 114. The communication unit 103 wirelessly receives 705 media comprising, for example, audio data, voice data, etc., from the portable electronic device 114 via the established wireless communication. The acoustic unit 107 of the WCARD 101 plays 706 the wirelessly received media. The WCARD 101 is therefore configured as a wireless portable speaker. In an embodiment, the sensing module 104 of the WCARD 101 determines availability of a docking station 113 based on response to a status request transmitted by the communication unit 103 to the docking station 113 for playing the wirelessly received media without interruption.

The method and wireless communication adaptor and receiver device (WCARD) 101 disclosed herein can be configured to work in a network environment comprising one or more computers that are in communication with one or more devices via a network. The computers may communicate with the devices directly or indirectly, via a wired medium or a wireless medium such as a wireless network such as Wi-Fi® of the Wi-Fi Alliance Corporation, a Bluetooth® network of Bluetooth Sig, Inc., a local area network (LAN), the Ethernet, a token ring, or via any appropriate communications mediums or combination of communications mediums. For example, Wi-Fi® and Bluetooth® enabled computers and devices can connect to and communicate with the WCARD 101. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The foregoing examples have been provided merely for the purpose of explanation and are in no way to be construed as limiting of the method and the wireless communication adaptor and receiver device (WCARD) 101 disclosed herein. While the method and the WCARD 101 have been described with reference to various embodiments, it is understood that the words, which have been used herein, are words of description and illustration, rather than words of limitation. Further, although the method and the WCARD 101 have been described herein with reference to particular means, materials, and embodiments, the method and the WCARD 101 are not intended to be limited to the particulars disclosed herein; rather, the method and the WCARD 101 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the WCARD 101 in their aspects.

I claim:

1. A wireless communication adaptor and receiver device comprising:
at least one device processor;
a communication unit operably coupled to said at least one device processor, said communication unit configured to wirelessly communicate with a portable electronic device;
one or more electrical connectors configured to connect to one or more of a docking station and said portable electronic device;
an authentication module configured to receive an authentication code from said portable electronic device for authenticating said portable electronic device;
an acoustic unit configured to play media received wirelessly from said portable electronic device;
a recording unit configured to receive and record input data from said portable electronic device via a communication interface, wherein said input data comprises one or more of audio data, voice data, and call data;
a non-transitory computer readable storage medium communicatively coupled to said at least one device processor, said non-transitory computer readable storage medium configured to store said received input data from said portable electronic device; and
a power charging unit configured to store and transmit power to said portable electronic device.

2. The wireless communication adaptor and receiver device of claim 1 configured to communicate with a device management system comprising at least one system processor provided on said portable electronic device, said at least one system processor configured to execute computer program instructions defined by modules of said device management system for remotely controlling and managing said wireless communication adaptor and receiver device, wherein said modules of said device management system comprise:
a networking module configured to configure said wireless communication adaptor and receiver device to connect to a wireless network;
a data communication module configured to wirelessly transmit said authentication code from said portable electronic device to said wireless communication adaptor and receiver device;
said data communication module further configured to wirelessly transmit said media from said portable electronic device to said wireless communication adaptor and receiver device;
said data communication module further configured to transmit said input data from said portable electronic device to said recording unit of said wireless communication adaptor and receiver device via said communication interface; and
a power module configured to activate said power charging unit of said wireless communication adaptor and receiver device for said transmission of said power from said power charging unit to said portable electronic device.

3. The wireless communication adaptor and receiver device of claim 1, wherein said acoustic unit is configured as one of a speaker, a microphone, and a combination thereof to receive and playback one or more of said media and said input data for establishing a duplex communication.

4. The wireless communication adaptor and receiver device of claim 1, further comprising a protocol translation unit configured to translate communication protocols of said portable electronic device and said docking station for establishing a wireless communication between said portable electronic device and said docking station, wherein said translation of said communication protocols performed by said protocol translation unit comprises:
translating a first communication protocol implemented by said portable electronic device to a second communication protocol implemented by said wireless communication adaptor and receiver device; and
translating said second communication protocol implemented by said wireless communication adaptor and receiver device to a third communication protocol implemented by said docking station.

5. The wireless communication adaptor and receiver device of claim 1, wherein said media comprises audio data and voice data.

6. The wireless communication adaptor and receiver device of claim 1, further comprising an auxiliary port configured to establish a wired communication with said portable electronic device.

7. The wireless communication adaptor and receiver device of claim 1, further comprising a sensing module configured to determine availability of said docking station based on a response to a status request transmitted by said communication unit to said docking station.

8. The wireless communication adaptor and receiver device of claim 1, wherein said communication unit is further configured to transmit said media received wirelessly from said portable electronic device to said docking station for play by said docking station, when said docking station is available.

9. A method for wirelessly playing media received from a portable electronic device on a wireless communication adaptor and receiver device, said method comprising:
providing said wireless communication adaptor and receiver device comprising at least one device processor, a communication unit operably coupled to said at least one device processor, an authentication module, and an acoustic unit;
receiving an authentication code from said portable electronic device by said authentication module of said wireless communication adaptor and receiver device;
authenticating said portable electronic device using said received authentication code by said authentication module;
establishing a wireless communication with said portable electronic device based on said authentication of said portable electronic device by said communication unit of said wireless communication adaptor and receiver device;
wirelessly receiving media from said portable electronic device by said communication unit via said established wireless communication; and
playing said wirelessly received media by said acoustic unit of said wireless communication adaptor and receiver device.

10. The method of claim 9, wherein said media comprises audio data and voice data.

11. The method of claim 9, wherein said authentication of said portable electronic device by said authentication module of said wireless communication adaptor and receiver device comprises matching said received authentication code with a set of predefined passwords stored in said wireless communication adaptor and receiver device.

12. The method of claim 9, further comprising receiving and playing one or more of said media and input data by said acoustic unit configured as one of a speaker, a microphone, and a combination thereof for establishing a duplex communication, wherein said input data comprises audio data and voice data.

13. The method of claim 9, further comprising translating a first communication protocol implemented by said portable electronic device to a second communication protocol implemented by said wireless communication adaptor and receiver device, by a protocol translation unit of said wireless communication adaptor and receiver device for establishing said wireless communication between said portable electronic device and said wireless communication adaptor and receiver device.

14. The method of claim 9, further comprising determining availability of a docking station by a sensing module of said wireless communication adaptor and receiver device based on a response to a status request transmitted by said communication unit to said docking station.
